(19) United States
(12) Patent Application Publication
(10) Pub. No.: US 2024/0070464 A1
(43) Pub. Date: Feb. 29, 2024

(54) SIMULATOR NEURAL NETWORK PREDICTION

(71) Applicant: X Development LLC, Mountain View, CA (US)

(72) Inventors: Alexandre Szenicer, London (GB); Bertrand Louis Rene Delorme, San Francisco, CA (US); Antoni Jordi Ballester, San Francisco, CA (US); Julia Black Ling, Menlo Park, CA (US)

(21) Appl. No.: 18/453,226

(22) Filed: Aug. 21, 2023

Related U.S. Application Data
(60) Provisional application No. 63/399,471, filed on Aug. 19, 2022.

(51) Int. Cl. G06N 3/084

(52) U.S. Cl. CPC G06N 3/084

(57) ABSTRACT

Methods, systems, and apparatus, including computer programs encoded on computer storage media, for combining a simulator and neural network for predictions, such as predictions of Harmful Algal Bloom (HAB). One of the methods includes obtaining an estimate of a first number of marine-life cells representative of growth of the marine-life within a first region; providing the estimate to a prediction system that comprises (i) an ocean simulator and (ii) a trained network model, wherein the trained network model is trained to provide an indication of marine-life change using output from the ocean simulator; obtaining output from the prediction system, wherein the output indicates a second number of cells representative of growth of the marine-life within a second region; comparing the output to an output threshold; and in response to the output satisfying the output threshold, performing an action.

### CROSS-REFERENCE TO RELATED APPLICATION

This application claims the benefit of U.S. Provisional Application No. 63/399,471, filed Aug. 19, 2022, the contents of which are incorporated by reference herein.

### FIELD

This specification generally relates to applications of machine learning, e.g., within an aquatic environment.

### BACKGROUND

Complex physical problems, such as Harmful Algal Bloom (HAB) forecasting, resist pure machine learning based problem solving. In the case of HABs, some species of marine algae can grow rapidly and produce detrimental effects on the environment. There are numerous noxious impacts from these events, such as economic loss due to mass mortalities of fish and shellfish, or public health issues due to the consumption of contaminated fish or exposure to toxins.

### SUMMARY

This document describes technology to predict complex marine conditions such as HAB by using a combination of a simulator and a trained model. HAB can be difficult to predict due to their rapid development and minimal warning signs. Difficulties can include the fact that different regions have different physical or biological mechanisms that can lead to HABs. HABs are generally the result of complex biogeochemical interactions that can include non-local effects (e.g., advection of nutrients or spores into a region from other surrounding regions). Techniques described in this document can improve on mere detection of HABs by predicting HABs before they appear, thereby potentially saving aquatic lives or preventing harm to ecosystems.

HABs can be monitored for in various ways. For example, water samples can be analyzed for chlorophyll content to determine if a HAB has started. However, forecasting remains elusive. A benefit of the proposed system is that it enables forecasting of HABs in the future (e.g., days or weeks). A fish farmer might decide to harvest fish early if they know that a HAB is likely in the next week as such a HAB could kill large portions, or all, of the fish in an ecosystem. The system can also include automated elements to automatically perform one or more actions (e.g., begin harvesting) in response to a prediction satisfying one or more thresholds. Once a bloom has started, it is often too late to harvest the fish because they will already be contaminated or dead.

In some implementations, a simulator is coupled to a neural network. The simulator can be differentiable for efficient coupling with a neural network. The neural network can perform auxiliary tasks. The neural network can be trained within one or more time steps of the simulator. For example, one or more simulator parameters can be updated at each step of the simulation based on neural network output.

In general, a simulator can model a physical process (e.g., advection-diffusion), which unfolds in time. To run the simulation, an expression representing a physical process can be solved, e.g., discretized in time and solved time-step by time-step, among other solution methods. In some implementations, techniques include alternating time-steps of the simulator with calls to the neural network. For example, for a first time step, subsequent values are generated by the simulator. For a second time step subsequent to the first time step, subsequent values are generated by a neural network. In some cases, the simulator and neural network are coupled to form a simulator-neural network system. In some implementations, a simulator-neural network system is trained together, e.g., updating one or more parameters in the simulator and weights in the neural network as one module. For example, the training system 100 can update one or more parameters of simulator 114 and one or more weights of neural network 112.

The simulator can include one or more representations of physical knowledge (e.g., fluid dynamics, gravity, kinetics, among others). In some implementations, by coupling a simulator with a neural network, existing physical knowledge can be utilized while learning unknown phenomena with the neural network. Although the technique is applicable to a variety of problems, this specification focuses on the example of HAB forecasting. In some implementations, a coupled simulator and neural network is used to generate predictions for other aquatic phenomena or other environments, such as non-aquatic, land, or atmospheric forecasting.

The techniques described enable forecasting of the onset of these HABs in advance (e.g., hours, days or weeks ahead of time). Forecasting can provide stakeholders with actions to perform to mitigate one or more detrimental consequences of events. In the case of HAB, actions can include sending signals configured to alert one or more users, signposting beaches exposed to toxins, or harvesting fish and shellfish early to avoid contamination or economic losses.

In general, data on HAB events are scarce and sparse. The mechanisms of bloom initiation are complex and typically not well understood, which can make it difficult to solve the problem with purely machine learning approaches. This specification describes a scientific machine learning (SciML) approach to the HAB forecasting problem, which can be used in other forecasting or predictive applications. The SciML approach can include using inductive biases of physics to constrain the problem. The SciML can provide forecasting (e.g., of the evolution of the HAB) including events such as propagation over time and termination.

In some implementations, inductive biases help to alleviate issues associated with sparseness of data. For example, techniques can include measuring data on HABs in water, e.g., phytoplankton concentrations, nutrients, temperature, among others. Techniques can include generating a model of the growth and decay of phytoplankton concentration. However, data observed might not be solely created by the growth and decay of phytoplankton. For example, observed growth and decay of phytoplankton can be a result of currents moving the phytoplankton cells in water. Expressions governing the transport of phytoplankton in currents can be used to correct for the effect such movement has on growth or decay.

In general, inductive biases can include using known movement of biomass, e.g., solving an advection-diffusion equation, to remove such movement effects from observed data representing biomass growth or decay. Such corrected data can be used to train a model for generating growth or decay predictions of biomass, such as phytoplankton.

In general, one aspect of the subject matter described in this specification can be embodied in methods that include the actions of obtaining an estimate of a first number of marine-life cells representative of growth of the marine-life within a first region; providing the estimate to a prediction system that comprises (i) an ocean simulator and (ii) a trained network model, wherein the trained network model is trained to provide an indication of marine-life change using output from the ocean simulator; obtaining output from the prediction system, wherein the output indicates a second number of cells representative of growth of the marine-life within a second region; comparing the output to an output threshold; and in response to the output satisfying the output threshold, performing an action.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, performing the action includes harvesting one or more fish in a vicinity of the second region. In some implementations, the first number of cells and the second number of cells represent a number of algae cells that contribute to harmful algal bloom. In some implementations, the ocean simulator is differentiable and the method includes updating one or more weights of an initial network model using backpropagation of errors through (i) the ocean simulator and (ii) the initial network model to generate the trained network model.

In some implementations, the prediction system is configured to generate cell number predictions through multiple iterations, wherein a particular iteration of the multiple iterations includes determining, using the ocean simulator, a water temperature in the first region and water current in the first region; and determining, using (i) the trained network model, (ii) the water temperature in the first region, and (iii) the current in the first region, a change in the first number of cells.

In some implementations, the ocean simulator includes an advection-diffusion module to perform numerical solutions. In some implementations, obtaining the estimate indicating the first number of cells includes obtaining satellite data; and determining the estimate using the satellite data. In some implementations, determining the estimate using the satellite data includes providing the satellite data to a second model trained using water samples to generate at least a portion of the estimate.

In some implementations, the ocean simulator is configured to forecast one or more of the following: temperature, salinity, or ocean currents. In some implementations, the actions include training the trained network model, wherein training includes training an initial network model within a time step of the ocean simulator.

This specification uses the term “configured to” in connection with systems, apparatus, and computer program components. That a system of one or more computers is configured to perform particular operations or actions means that the system has installed on its software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. For example, early detection or prediction of a HAB can reduce effects on local communities, e.g., fish, aquaculture, ecosystems, among others. In some implementations, early detection or prediction is used to implement mitigation measures. For example, mitigation measures can include deploying one or more vessels. Mitigation measures can include deploying a substance, e.g., chemicals or compounds, to help reduce or eliminate HAB generation or growth. Mitigation measure can include deploying a substance to help protect an ecosystem—e.g., increasing resiliency of the ecosystem against a HAB.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A is a diagram showing an example training system for simulator neural network prediction.

FIG. 1B is a diagram showing an example representation of a neural network and simulator.

FIG. 2 is a flow diagram illustrating an example of a system for simulator neural network prediction.

FIG. 3 is a flow diagram of an example process for predicting growth of marine-life.

FIG. 4 is a block diagram of computing devices for simulator neural network prediction.

Like reference numbers and designations in the various drawings indicate like elements.

### DETAILED DESCRIPTION

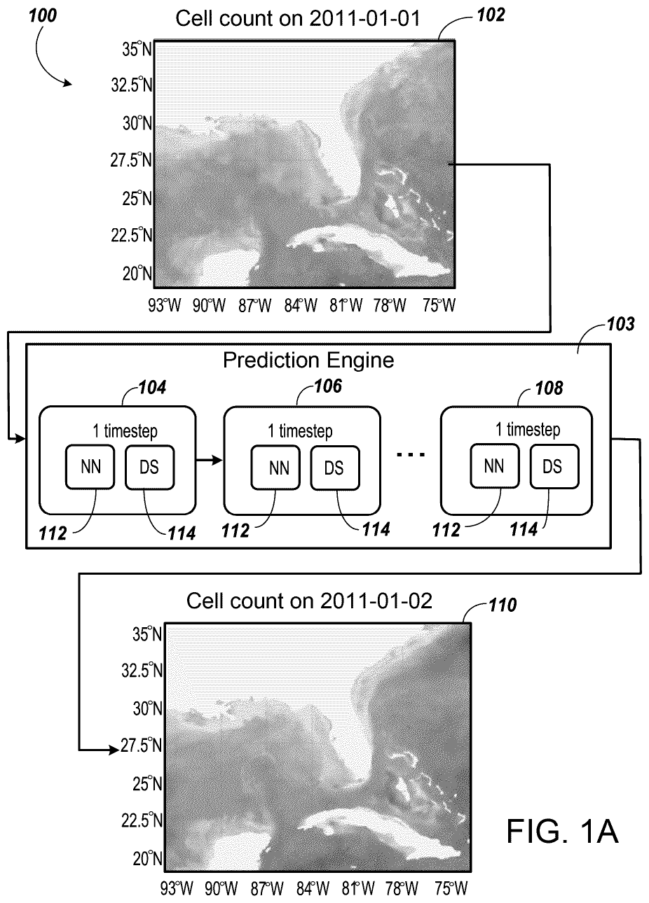

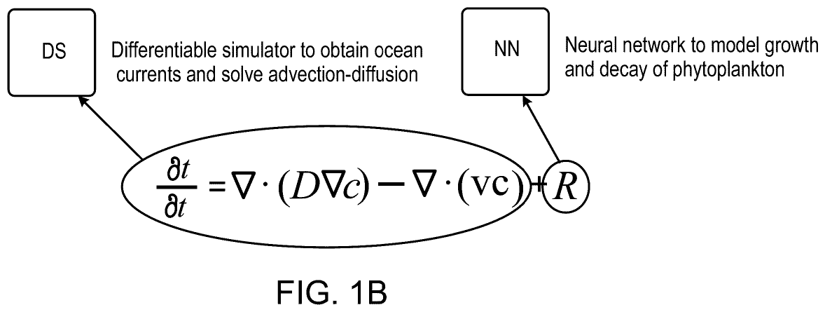

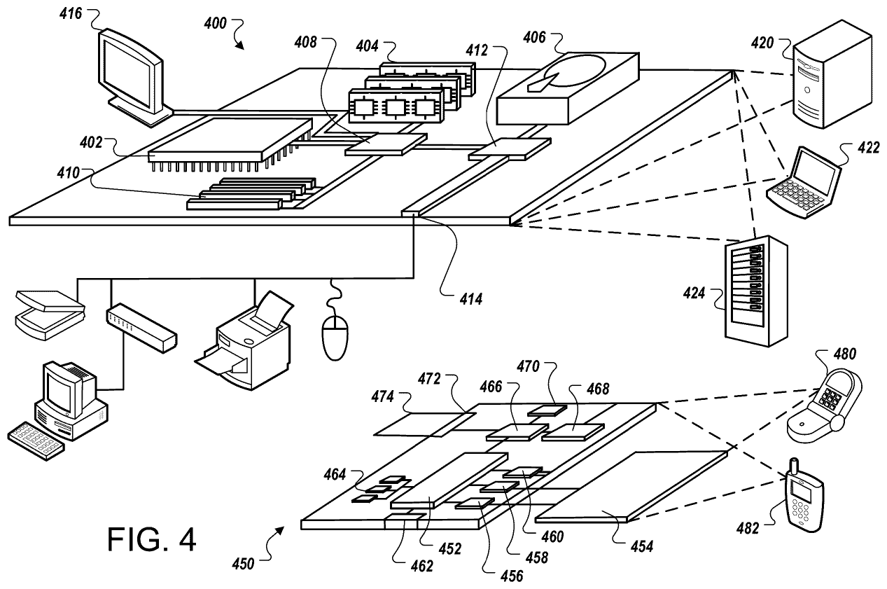

FIG. 1A is a diagram showing an example training system 100 for simulator neural network prediction. Processes performed by the system 100 may be performed by one or more electronic systems, for example, the computing devices 300, 350 of FIG. 4. The system 100 represents a training workflow for one sample for a HAB evolution application. The system 100 includes a prediction engine 103 that implements multiple iterations of a neural network and simulator to generate biomass predictions. The details of simulator neural network prediction are described with reference to this specific problem, but it is contemplated that the techniques can be used in other fields. For example, differentiable simulators augmented with neural networks can be used to model poorly understood ocean-atmosphere coupling phenomena, approximate small-scale ocean mixing, among others.

In some implementations, the simulator neural network prediction approach is implemented by a system that includes a differentiable ocean simulator. The differentiable ocean simulator can include a physics-based partial differential equation solver implemented in a differentiable programming language (e.g., TensorFlow of JAX). An example of a differential equation used in one or more simulations, such as the simulator 114, is shown in FIG. 1B.

In some implementations, the simulator 114 solves one or more differential equations representing one or more physical processes. For example, the simulator 114 can solve a differential equation shown in FIG. 1B representing a process of advection-diffusion. The simulator 114 can implement a process to solve the differential equation using one or more computers. In some implementations, the simulator 114 is a differentiable simulator. For example, the simulator 114 can be a simulator implemented in a programming framework that has a property of being differentiable, e.g., it allows the simulator to be differentiated throughout using automatic differentiation. Frameworks for automatic differentiation include TensorFlow, Jax, or PyTorch.

FIG. 1A is a schematic diagram illustrating iterations of a simulator and neural network based prediction system 100. Iterations 104, 106, and 108 each include an instance of a neural network 112 and a simulator 114. The neural network 112 and the simulator 114 obtain cell counts of phytoplankton at a first time 102 and generate a prediction of cell counts of phytoplankton at a second time 110. In some implementations, the simulator 114 is differentiable. In some implementations, simulator 114 is configured to obtain ocean currents. In some implementations, the simulator 114 is configured to solve advection-diffusion. In some implementations, the neural network 112 is configured to model growth and decay of phytoplankton.

The neural network 112 and the simulator 114 can produce forecasts of oceanic variables such as temperature, salinity, and ocean currents. The neural network 112 and the simulator 114 can propagate passive tracers such as chlorophyll using additional modules such as advection-diffusion numerical solvers. In some implementations, the simulator 114 is differentiable and coupled to the neural network 112. The neural network 112 can perform auxiliary tasks. The simulator 114 can be used (e.g., by an implementing computer device) to train the neural network 112 within a time loop of the simulator 114. In this way, existing physics knowledge can be utilized by the simulator 114, while the neural network 112 learns unknown phenomena. This setup is applicable to a wide variety of problems. For clarity and ease of discussion, the example of HAB forecasting is discussed.

A system, such as the system 100, including the neural network 112 and the simulator 114 obtains information indicating a distribution of chlorophyll (e.g., obtained through satellite imagery) or a distribution of cell counts (e.g., obtained through a ML model trained on water samples). The information can represent data from a region of space and time (e.g., west coast of Florida).

The simulator 114 generates a simulation of an ocean. In some implementations, the simulator 114 generates one or more values indicating temperature, salinity, or ocean current forecasts. In some implementations, the simulator 114 includes an advection-diffusion module. The simulator 114, together with the neural network, propagates from obtained information (e.g., an obtained distribution of cell counts) forward in time.

In some implementations, an advection-diffusion module represents, e.g., using one or more expressions, how biomass is transported by ocean currents. For example, an advection-diffusion module that can be used in the simulator 114 can represent how phytoplankton cells are transported by oceanic currents (e.g., advection) and diffusion. The advection-diffusion module can provide inductive biases which can be incorporated into modeling to focus on learning specific features, e.g., a growth or decay process of particular biomass, such as phytoplankton.

The system including the neural network 112 and the simulator 114 progresses through multiple time steps. In some implementations, each time step includes a run of the neural network 112 to create or destroy phytoplankton then a run of the simulator 114 (e.g., the advection diffusion part) to propagate the plankton according to currents. In some implementations, processes of the neural network 112 happen concurrently within time stepping of the simulator 114.

After an amount of time, the system including the neural network 112 and the simulator 114 compares predictions of the neural network 112 and the simulator 114 to ground truth data. For example, once propagation has reached a full day, the system can compare predictions of chlorophyll/cell counts to ground truth chlorophyll/cell counts of that day. The system can back propagate errors through the neural network 112 and the simulator 114 to update weights of the neural network 112. In some implementations, backpropagation is feasible because the simulator 114 is written in a differentiable language.

A system including the neural network 112 and the simulator 114 can be used for forecasting the onset, spread, and termination of other algae and phytoplankton blooms as well (e.g., non-harmful phytoplankton). A system including the neural network 112 and the simulator 114 can be applied to predicting dispersion of oil spills, marine debris, among others, (e.g., passive scalars).

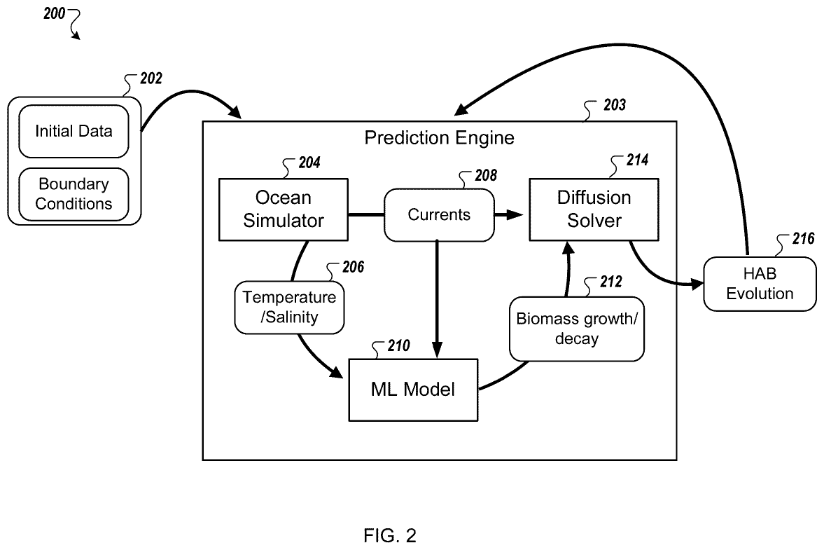

FIG. 2 is a flow diagram illustrating an example of a system 200 for simulator neural network prediction. The system 200 may be performed by one or more electronic systems, for example, the computing devices 300, 350 of FIG. 4.

The system 200 includes a prediction engine 203. The prediction engine 203 can be a particular implementation of the prediction engine 103, and vice versa. The prediction engine 203 can obtain initial data 202. The initial data 202 can include data from satellites or sensors. The system 200 can use the initial data 202 to set a boundary or initial conditions for an ocean simulation. The initial data 202 can include an estimate of a first number of marine-life cells representative of growth of the marine-life within a first region—e.g., growth of phytoplankton in an area of ocean. The initial data 202 can include derived quantities—e.g., a concentration of cells in water, such as cells per liter. A high concentration of cells can indicate cells in the tens of thousands per liter.

The system 200 includes a simulator 204. For example, the simulator 204 can include a physics-based ocean simulation. The simulator 204 can include a differentiable simulator. The simulator 204 can include simulations of currents alone, or for currents and wave heights, or for currents, wave heights and biogeochemical quantities. The simulator 204 can solves physics-based equations on a discretized grid.

The system 200 includes a machine learning model 210. The machine learning model 210 generates predictions. In some implementations, the machine learning model 210 generates predictions concurrently (e.g., within a time-loop of the simulator 204). The machine learning model 210 can generate predictions for any type of application. For example, in the HAB example considered, the machine learning model 210 can generate predictions of growth or decay of phytoplankton—e.g., biomass growth/decay 212—based on oceanic variables produced by the simulator 204.

In some implementations, the machine learning model 210 obtains one or more values from the simulator 204. For example, the machine learning model 210 can obtain one or more values representing temperature and salinity 206 or ocean currents 208. The simulator 204 can generate the temperature and salinity 206 and the ocean currents 208 using one or more physical properties configured in the simulator 204.

The system 200 includes the simulator 204 providing data to a numerical solver 214 (e.g., an advection diffusion solver). Concurrently (e.g., within a time loop of the simulator 204), the numerical solver 214 module of the simulator 204 can transport a passive tracer (in this example phytoplankton) according to oceanic currents produced by the simulator 204, including the growth/decay contributions of the machine learning model 210. In some implementations, the passive tracer includes the growth/decay contributions of the machine learning model 210.

The system 200 includes generating a prediction 216. The prediction 216 can include a distribution of phytoplankton at one or more time steps of the simulator 204. The prediction 216 can be provided (e.g., by an implementing system) as input to the prediction engine 203 to generate additional iterations of predictions, similar to the process shown in FIG. 1A—e.g., back into the machine learning model 210 and numerical solver 214 for a next time step. By simulating over many time steps, an implementing system can predict onset, growth, and termination of HABs. In some implementations, the prediction 216 is indicative of a second region. For example, the prediction 216 can indicate how an initial set of cells—indicated by the initial data 202— develops and moves from a first region to a second region.

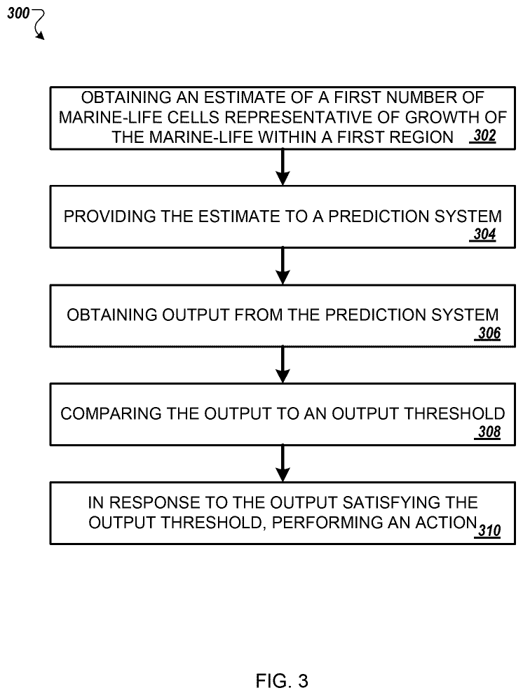

FIG. 3 is a flow diagram of an example process 300 for predicting growth of marine-life. For example, the process 300 can be used by the system 100 as shown in FIGS. 1A and 1B.

The process 300 includes obtaining an estimate of a first number of marine-life cells representative of growth of the marine-life within a first region (302). For example, the system 100 can obtain cell counts of phytoplankton at the first time 102. The cell counts can be obtained from a machine learning model, sensors within the region, known starting conditions—e.g., from local expert knowledge—satellite data, among other sources.

The process 300 includes providing the estimate to a prediction system (304). For example, the system 100 can provide the estimate to the prediction engine 103. The prediction engine can include one or more steps of simulation and machine learning model augmentation, as described in this document.

The process 300 includes obtaining output from the prediction system (306). For example, the system 100 can obtain cell counts of phytoplankton at a second time 110. In general, any other form of biomass can be estimated. The output can be a result of multiple iterations of simulation and machine learning augmentation, as described in this document, e.g., in reference to FIG. 1A and FIG. 1B.

The process 300 includes comparing the output to an output threshold (308). For example, the system 100 can include one or more components that obtain a predicted biomass estimate and compare the prediction to a threshold value. The threshold value can indicate a number of cells, a rate of increase, or other quantity of interest.

The process 300 includes in response to the output satisfying the output threshold, performing an action (310). For example, the system 100 can generate a signal indicating the one or more fish should be harvested—e.g., in advance of a HAB predicted by the system 100. The action can include providing an indication, e.g., on a user interface, of the HAB or other values related to the aquatic life prediction. The action can include controlling one or more actuating devices to perform operations—e.g., sorting fish from one area to another, such as out of harms way from a HAB.

The order of operations in the process 300 described above is illustrative only and can be performed in different orders. In some implementations, the process 300 can include additional operations, fewer operations, or some of the operations can be divided into multiple operations.

FIG. 4 is a block diagram of computing devices 400, 450 that may be used to implement the systems and methods described in this specification, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this specification.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method for predicting growth of marine-life cells of a particular type, the method comprising:
obtaining an estimate of a first number of marine-life cells representative of growth of the marine-life within a first region;
providing the estimate to a prediction system that comprises (i) an ocean simulator and (ii) a trained network model, wherein the trained network model is trained to provide an indication of marine-life change using output from the ocean simulator;
obtaining output from the prediction system, wherein the output indicates a second number of cells representative of growth of the marine-life within a second region;
comparing the output to an output threshold; and
in response to the output satisfying the output threshold, performing an action.

2. The method of claim 1, wherein performing the action comprises:
harvesting one or more fish in a vicinity of the second region.

3. The method of claim 1, wherein the first number of cells and the second number of cells represent a number of algae cells that contribute to harmful algal bloom.

4. The method of claim 1, wherein the ocean simulator is differentiable and the method comprises:
updating one or more weights of an initial network model using backpropagation of errors through (i) the ocean simulator and (ii) the initial network model to generate the trained network model.

5. The method of claim 1, wherein the prediction system is configured to generate cell number predictions through multiple iterations, wherein a particular iteration of the multiple iterations comprises:
determining, using the ocean simulator, a water temperature in the first region and water current in the first region; and
determining, using (i) the trained network model, (ii) the water temperature in the first region, and (iii) the current in the first region, a change in the first number of cells.

6. The method of claim 1, wherein the ocean simulator includes an advection-diffusion module to perform numerical solutions.

7. The method of claim 1, wherein obtaining the estimate indicating the first number of cells comprises:
obtaining satellite data; and
determining the estimate using the satellite data.

8. The method of claim 7, wherein determining the estimate using the satellite data comprises:
providing the satellite data to a second model trained using water samples to generate at least a portion of the estimate.

9. The method of claim 1, wherein the ocean simulator is configured to forecast one or more of the following: temperature, salinity, or ocean currents.

10. The method of claim 1, comprising training the trained network model, wherein training comprises:
training an initial network model within a time step of the ocean simulator.

11. One or more non-transitory computer storage media encoded with instructions that, when executed by one or more computers, cause the one or more computers to perform operations comprising:
obtaining an estimate of a first number of marine-life cells representative of growth of the marine-life within a first region;
providing the estimate to a prediction system that comprises (i) an ocean simulator and (ii) a trained network model, wherein the trained network model is trained to provide an indication of marine-life change using output from the ocean simulator;
obtaining output from the prediction system, wherein the output indicates a second number of cells representative of growth of the marine-life within a second region;
comparing the output to an output threshold; and
in response to the output satisfying the output threshold, performing an action.

12. The media of claim 11, wherein performing the action comprises:
harvesting one or more fish in a vicinity of the second region.

13. The media of claim 11, wherein the first number of cells and the second number of cells represent a number of algae cells that contribute to harmful algal bloom.

14. The media of claim 11, wherein the ocean simulator is differentiable and the operations comprise:
updating one or more weights of an initial network model using backpropagation of errors through (i) the ocean simulator and (ii) the initial network model to generate the trained network model.

15. The media of claim 11, wherein the prediction system is configured to generate cell number predictions through multiple iterations, wherein a particular iteration of the multiple iterations comprises:
determining, using the ocean simulator, a water temperature in the first region and water current in the first region; and
determining, using (i) the trained network model, (ii) the water temperature in the first region, and (iii) the current in the first region, a change in the first number of cells.

16. The media of claim 11, wherein the ocean simulator includes an advection-diffusion module to perform numerical solutions.

17. The media of claim 11, wherein obtaining the estimate indicating the first number of cells comprises:
obtaining satellite data; and
determining the estimate using the satellite data.

18. The media of claim 17, wherein determining the estimate using the satellite data comprises:
providing the satellite data to a second model trained using water samples to generate at least a portion of the estimate.

19. The media of claim 11, wherein the ocean simulator is configured to forecast one or more of the following: temperature, salinity, or ocean currents.

20. A system comprising one or more computers and one or more storage devices on which are stored instructions that are operable, when executed by the one or more computers, to cause the one or more computers to perform operations comprising:
obtaining an estimate of a first number of marine-life cells representative of growth of the marine-life within a first region;
providing the estimate to a prediction system that comprises (i) an ocean simulator and (ii) a trained network model, wherein the trained network model is trained to provide an indication of marine-life change using output from the ocean simulator;
obtaining output from the prediction system, wherein the output indicates a second number of cells representative of growth of the marine-life within a second region;
comparing the output to an output threshold; and
in response to the output satisfying the output threshold, performing an action.
